(19) United States
(12) Patent Application Publication
(10) Pub. No.: US 2008/0215164 A1
(43) Pub. Date: Sep. 4, 2008

(54) Method and Device for Controlling Movement of a Movable Machine Element of a Machine

(75) Inventors: Joachim Denk, Nurnberg (DE); Elmar Schafers, Furth (DE); Bernd Wedel, Mohrendorf (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, MUNCHEN (DE)

(21) Appl. No.: 11/997,813

(22) PCT Filed: Jul. 13, 2006
(86) PCT No.: PCT/EP2006/064189

§ 371 Date: Feb. 4, 2008

(30) Foreign Application Priority Data
Aug. 4, 2005 (DE) 10 2005 036 848.4

(51) Int. Cl. G05B 19/416; G06G 7/48

(52) U.S. Cl. 700/29; 703/7

(57) ABSTRACT

The movement of a machine element associated with a machine axis of a machine is simulated with a model by inputting in the model a movement to be performed by the machine element, and determining with the model at least one of a position profile, a velocity profile and a torque profile suitable for optimized movement of the movable machine element, as well as a predetermined quality function and a limitation for the movement of the machine axis. The position profile, velocity profile or torque profile is then used as a reference or pilot control variable in a control loop to control the moving machine element. The predetermined quality function is an integral of the square of a torque or of a variable which is directly related to the torque. The method can be used to optimize the guided movement of the machine element.

The invention relates to a method and a device for movement control of a movable machine element of a machine.

In many machines, such as machine tools, production machines and/or robots, a machine element must be moved from an initial position to a new position, that is to say to a new location, which must be reached within, for example, a predetermined movement duration, by movement of a motor. In order to allow the movement, appropriate nominal variable profiles for control of the machine must be calculated in advance in the normal manner by calculation of movement profiles. The static and dynamic relationship between, for example, a rotor position of the motor and the position of the machine element may in this case be subject to linear or non-linear rules. The movement duration may either be predetermined as being fixed, or the aim may be to minimize it in order to increase production. At the same time, it is necessary to ensure that the technical limits of the machine, such as maximum velocities and maximum torques of the individual machine axes, are complied with during the resultant movement of the machine element. Although the mechanism located between the motor and the machine element is always a system that can oscillate in physical systems, this aspect is currently ignored when calculating the reference variables and pilot-control variables for commercially available machines. The mechanism is assumed to be a rigid single body whose jerk, acceleration and velocity capability is limited. Dynamic effects are therefore largely ignored from the prior calculation of the position profile and of the pilot-control variables. For this reason, for example, the position of the machine element, such as the position of a tool, does not follow the position profile calculated in advance with respect to the elapsed time even when the position profile is applied to the motor. Instead of this, the tool can be observed to oscillate, and the intended position as well as the intended velocity are not achieved.

In consequence, the movement profile must frequently be modified by means of a trial and error process and, for example, must be slowed down by jerk limiting, such that the oscillations are excited only to an extent that is permissible for the application. A further range of problems occurs when, for example, major regulator activities are initiated as a result of the load mass oscillating with respect to the motor, in this case resulting in motor torque profiles with very much higher contributions than those calculated in advance on the basis of the rigid body assumption from the reference variable profiles. If this results in the maximum motor torques being exceeded, the control loop is virtually open, and the control aim is unsuccessful. In this case as well, the reference variables and/or pilot-control variables must at that moment also be manually adapted in a suitable manner subsequently, for example by means of acceleration limiting.

Optimum control methods are known from the document “Optimierung, Statische, dynamische, stochastische Verfahren für die Anwendung” [Optimization, static, dynamic, stochastic methods for application], Markos Papageorgiou, 2^{nd} edition, R. Oldenbourg Verlag, Munich, Vienna 1996, ISBN 3-486-23775-6, pages 11 to 14, pages 76 to 85, pages 143 to 145, pages 156 to 159, pages 407 to 417.

The invention is based on the object of providing a simple method and a device for movement control of a movable machine element of a machine, which allows optimized movement control of a movable machine element.

This object is achieved by a method for movement control of a movable machine element of a machine, having the following method steps:
a) creation of a model which simulates a machine axis,
b) input of a movement which the machine element can carry out,
c) determination of a position profile, which is suitable for optimized movement of the movable machine element, and/or of a velocity profile, which is suitable for the optimized movement of the movable machine element, and/or of a torque profile, which is suitable for the optimized movement of the movable machine element, on the basis of the model, of a predetermined quality function and of restrictions to the movement of the machine axis.

This object is also achieved by a device for movement control of a movable machine element of a machine, with the device having,
means for creation of a model which simulates a machine axis,
means for inputting a movement to be carried out by the machine element,
means for determining a position profile, which is suitable for an optimized movement of the movable machine element, and/or a velocity profile, which is suitable for the optimized movement of the movable machine element, and/or a torque profile, which is suitable for the optimized movement of the movable machine element, on the basis of the model, of a predetermined quality function and of restrictions to the movement of the machine axis.

A first advantageous embodiment of the invention is characterized in that, in step b), the final position and/or the initial position of a movement to be carried out by the machine element is input. A movement to be carried out by the machine element is normally defined by inputting the final position and/or the initial position.

Furthermore, it has been found to be advantageous if, in step b), the movement velocity at the initial position and/or the final position is additionally input. The desired movement profile can be defined more exactly by inputting the movement velocity at the initial position and/or the final position.

Furthermore, it has been found to be advantageous if, in step b), the movement duration between the initial position and the final position is additionally input. The desired movement duration for the movement process can be predetermined exactly by inputting the movement duration between the initial position and the final position.

Furthermore, it has been found to be advantageous if the integral of the square of a torque or of a variable which is directly related to it is provided as the quality function. This allows particularly good optimization of the movement of the movable machine element.

Furthermore, it has been found to be advantageous if the model is created on the basis of frequency response measurements and/or machine parameters and/or parameter estimation methods. The model can be created virtually completely automatically by the use of frequency response measurements, machine parameters and/or parameter estimation methods.

Furthermore, it has been found to be advantageous if a formula for configuration of the model is used during the creation of the model, with the formula being selected by the user from a list of formulae for typical machine types and/or machine kinematics. This creates a simple model configuration capability for the user.

Furthermore, it has been found to be advantageous if a mass model which simulates exclusively the mechanics of the machine axis is used as the model, since a model such as this can generally be determined easily.

Furthermore, it has been found to be advantageous if the device additionally has a position regulator, to which the difference between the actual position and the suitable position profile is supplied, and which outputs a nominal velocity on the output side, and a velocity regulator, to which the sum of the nominal velocity and the suitable velocity profile minus an actual velocity is supplied, and which outputs a nominal torque on the output side. This allows exact movement control.

Furthermore, it has been found to be advantageous if the device additionally has summing means, which determines the sum of the nominal torque and the suitable torque profile and whose output variable influences the magnitude of a motor current. This allows exact movement control.

Furthermore, it has been found to be advantageous if a first delay element is provided, in that the suitable position profile is delayed in time before the difference between the actual position and the suitable position profile is supplied as an input variable to the position regulator. This allows the timing of the position profile to be matched to the delay time of the current control loop.

Furthermore, it has been found to be advantageous for the machine to be a machine tool, a production machine and/or a robot. Particularly in the case of machine tools, production machines and/or robots, oscillation problems occur with respect to movement control. The invention may, of course, however also be used for other machines.

Furthermore, it has been found to be advantageous to provide a computer program product for the device according to the invention, which contains code sections by means of which the method can be carried out.

Advantageous embodiments of the method result analogously in advantageous embodiments of the device, and vice versa.

One exemplary embodiment of the invention is explained in more detail in the following text and is illustrated in the drawing, in which:

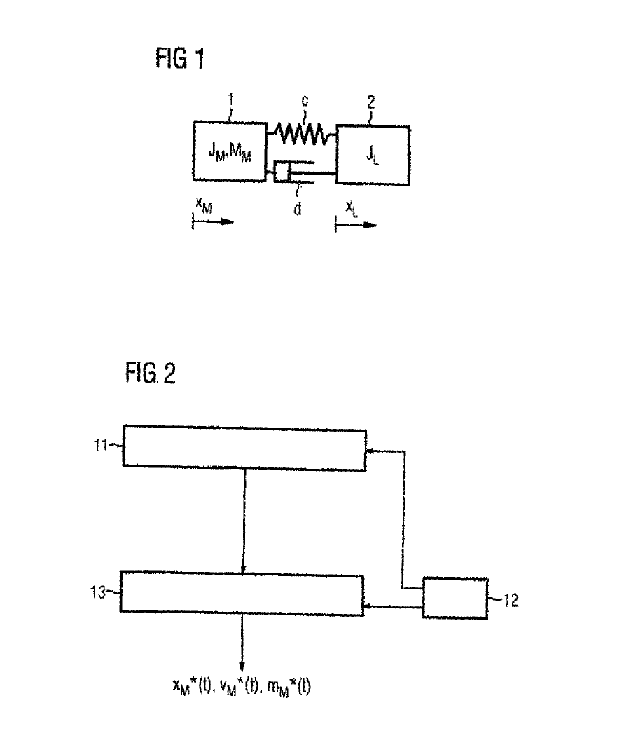

FIG. 1 shows a schematic illustration of a two-mass oscillating system,

FIG. 2 shows a schematic illustration of a device for movement control of a movable machine element of a machine, and

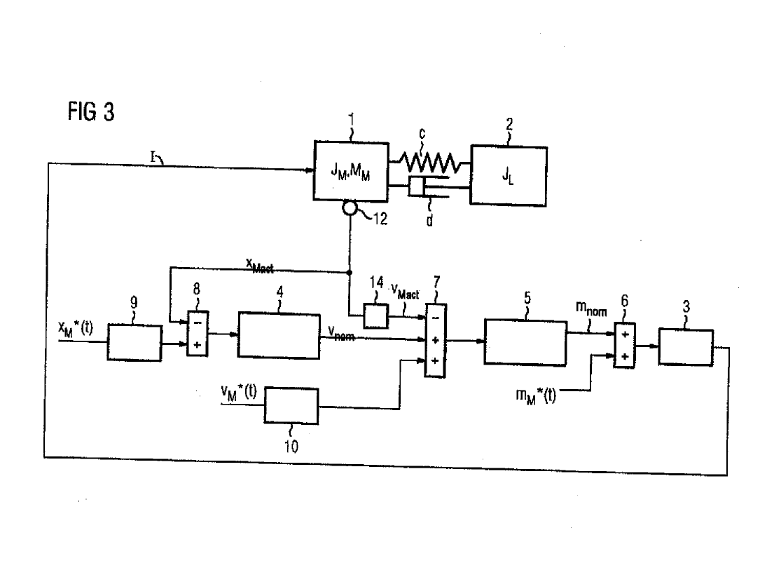

FIG. 3 shows a control loop associated with the device.

FIG. 1 shows a schematic illustration of a two-mass oscillating system comprising a motor 1 which is connected to a load 2. The motor 1 has a load inertia J_{M} and a motor torque M_{M}. The load has a load inertia J_{L}. The connection between the motor 1 and the load 2 has a stiffness c and a damping d. The connection may, for example, be in the form of a gearbox. When the position x_{M} of the rotor of the motor 1 changes (x_{M}=rotor position angle), as a consequence of the finite torsional stiffness, in particular for dynamic situations, inter alia, the position of the load x_{L} does not change as would be expected just by a change in the position of the motor x_{M}, but the position of the load x_{L} starts to oscillate with respect to the position of the motor x_{M}. The system dynamics of the two-mass oscillating system shown in FIG. 1 with the motor torque M_{M} is described mathematically by the following second-order differential equation system:

J_{M}·\ddot{x}_{M}+d·(\dot{x}_{M}−\dot{x}_{L})+c·(x_{M}−x_{L})=M_{M}

J_{L}·\ddot{x}_{L}−d·(\dot{x}_{M}−\dot{x}_{L})−c·(x_{M}−x_{L})=0 (1)

The following substitutions:

x₁=x_{M}=x_{M}(t), x₂=x_{L}, x₃=\dot{x}_{M}=v_{M}(t), x₄=\dot{x}_{L}, u=M_{M}=m_{M}(t) (2)

(where the index “*” denotes the optimum profile) result in the final system description of the model in state form:

\dot{x}₁=x₃

\dot{x}₂=x₄

\dot{x}₃=J_{M}⁻¹·[−d·(x₃−x₄)−c·(x₁−x₂)+u]

\dot{x}₄=J_{L}⁻¹·[d·(x₃−x₄)+c·(x₁−x₂)] (3)

or for short

\dot{x}=f(x,u) (4)

with the state vector

x=[x₁ x₂ x₃ x₄]^{T}. (5)

As already described above, the method starts with the creation of a model which simulates a machine axis. In this case, the model may be either, as in the exemplary embodiment, in the form of a mass model which simulates exclusively the mechanics of the machine axis (that is to say for example without simulating components of the closed-loop control, open-loop control or further dynamic components) or in the form of a more comprehensive model, which includes not only the simulation of the mechanics of the machine axis but also a simulation of other components (that is to say for example a simulation of components of the closed-loop control, open-loop control and/or further dynamic components). In the exemplary embodiment, the machine axis is defined essentially by the motor 1 and the load 2, and in this case the load 2 can be regarded as an example of a movable machine element. The parameters which are suitable for the creation of the model, such as the torsional stiffness c and damping d, can be determined by means of frequency response measurements and/or parameter estimation methods. Machine parameters such as the maximum motor torque Mₘₐₓ are known from the manufacturer's data, from the motor manufacturer.

In the method according to the invention, once the model has been created, a movement to be carried out by the machine element is input. In the simplest case, a final position and/or an initial position of a movement to be carried out by the machine element is input in this case. For the purposes of this input, additional inputs may also be provided, for example an input of the desired movement velocity, for example of the movable machine element at the initial and/or final position. Additionally or alternatively, the movement duration between the initial position and the final position can also be input. The inputs provided in this way represent restrictions to the movement of the machine axis. Furthermore, additional restrictions exist to the possible movement of the machine axis, for example in the form of the maximum possible motor torque Mₘₐₓ and, for example, in the form of the maximum possible motor rotation speed Ωₘₐₓ. These restrictions may either be permanently stored, or else they may likewise be input.

The restrictions relating to the maximum possible motor torque and the maximum possible motor rotation speed can be formulated in the exemplary embodiment in the form of three secondary inequality conditions:

−Mₘₐₓ<u<Mₘₐₓ

−Ωₘₐₓ<x₃<Ωₘₐₓ

−Ωₘₐₓ<x₄<Ωₘₐₓ (6)

In principle, these restrictions could also be replaced by consideration of the torque/rotation-speed characteristic of the motor as secondary inequality conditions. Furthermore, secondary inequality conditions could be introduced, for example, in order to limit the maximum converter voltage for supplying voltage to the motor.

In a further step, a position profile which is suitable for optimized movement of the movable machine element and/or a velocity profile which is suitable for optimized movement of the movable machine element and/or a torque profile which is suitable for optimized movement of the movable machine element is now determined on the basis of the model, a predetermined quality function and restrictions to the movement of the machine axis.

On the basis of the system description as stated above, the problem of reference-variable generation for optimized movement of the movable machine element for a point-to-point movement of the time duration tₑ from a desired initial system state x(0) to the corresponding final system state x(tₑ) can now be reduced to the solution of an optimum control problem. Without any restriction to generality, the following text is based on the assumption that the motor inertia and load inertia at the start of the desired movement should be zero at the position x₁(0)=x₂(0)=0, that is to say X3(0)=X4(0)=0. The aim is to reach the final position x₁(tₑ)=x₂(tₑ)=xₑ such that the two inertias are once again zero, that is to say x₃(tₑ)=X₄(tₑ)=0.

By way of example, minimizing the integral over time of the square of a torque, in particular of the square of the motor torque, can be used as a quality function (see equation (7)). In consequence, the oscillation excitation of the movable machine element is suppressed. Alternatives to this are other suitable quality functions, which have the general form:

$$J [ x ( t ) , u ( t ) , {t}_{e} ] = ϑ [ x ( {t}_{e} ) , {t}_{e} ] + {\int }_{0}^{{t}_{e}} φ [ x ( t ) , u ( t ) , t ] d t$$

The associated optimum control problem will be described first of all mathematically in the following text using the normal notation for optimum control problems, followed by a clear description in words:

$${min}_{u ( t )} J = {\int }_{0}^{{t}_{e}} {u}^{2} ( t ) d t ( quality function ) \qquad ( 7 )$$

taking account of the system state differential equation:

[symbol]

=f(x,u)

the secondary inequality condition in order to comply with the velocity restriction:

−Ωₘₐₓ<x₃<Ωₘₐₓ, −Ωₘₐₓ<x₄<Ωₘₐₓ

the secondary inequality condition in order to comply with the torque restriction:

−Mₘₐₓ<u<Mₘₐₓ

as well as the constraints relating to the initial position and final position of the inertias:

x₁(0)=x₂(0)=x₀=0; x₁(tₑ)=x₂(tₑ)=x₂

at the initial and final velocities of the inertias:

x₃(0)=x₄(0)=Ω₀=0; x₃(tₑ)=x₄(tₑ)=Ωₑ=0

or, expressed in words;

Use all the possible time profiles of the motor torque u(t) which move the system from an initial state x(0) to the final state X(tₑ) within the time tₑ with the torque restriction as well as the velocity restriction being complied with, to determine the specific time profile m_{M}*(t) at which the integral of the square of the motor torque u(t) is a minimum. The initial state x(0) is specified in that the motor and load are stationary, that is to say x₃(0)=x₄(0)=0 at their initial position, that is to say x₁(0)=x₂(0)=0. The final state x(tₑ) to be reached is distinguished by the motor and load likewise being stationary, that is to say x₃(tₑ)=x₄(tₑ)=0 at their final position, that is to say x₁(tₑ)=x₂(tₑ)=xₑ.

The mathematical solution of an optimization problem such as this is generally known by those skilled in the art. For example, pages 407 to 415 of the document “Optimierung, Statische, dynamische, stochastische Verfahren für die Anwendung” [Optimization, static, dynamic, stochastic methods for application], Markos Papageorgiou, 2^{nd} edition describe how the optimization problem stated above can be converted, in order to allow it to be solved numerically, for example by means of coordinate functions, to a static parameter optimization problem. The general problem of static optimization is described on pages 11 to 14 of this document. The required optimality conditions in order to minimize the function in secondary equality conditions are described on pages 76 to 85 of this document. The principle of sequential square programming, which is described on pages 156 to 159 of this document, is built on these conditions and allows numerical solution of the optimization problem. The cited pages of the document represent components of the disclosure of the present application.

The optimization problem is solved by the position profile x_{M}*(t) of the motor 1 which is suitable for optimized movement of the movable machine element, the velocity profile v_{M}*(t) of the motor 1 which is suitable for movement of the movable machine element, and the torque profile m_{M}*(t) of the motor I which is suitable for movement of the movable machine element.

FIG. 2 shows a device for movement control of a movable machine element of a machine. In a corresponding manner to the method, the device has a means for creation of a model which simulates a machine axis, in the form of a model creation means 11. Furthermore, the device has a means for determination of a position profile x_{M}*(t) which is suitable for optimized movement of the movable machine element and/or a velocity profile v_{M}*(t) which is suitable for optimized movement of the movable machine element, and/or a torque profile m_{M}*(t) which is suitable for optimized movement of the movable machine element on the basis of the model, of a predetermined quality function and of restrictions to the movement of the machine axis, in the form of an optimization means 13.

The input data can be made available to the optimization means 13 by the input means 12. Furthermore, if necessary, data can also be passed to the model creation means 11 by the input means 12. The suitable position profile x_{M}*(t) and/or the suitable velocity profile v_{M}*(t) and the suitable torque profile m_{M}*(t) are determined within the optimization means 13.

The suitable position profile, suitable velocity profile and suitable torque profile determined in this way may, for example, be used in a control loop as reference and/or pilot-control variable in order to control the movable machine element of a machine.

FIG. 3 illustrates one example of a control loop such as this. In this case the aim is to move the system that is already known from FIG. 1 and comprises the motor 1 and the movable machine element, which is in the form of a load 2 in the exemplary embodiment. The actual position x_{Mact} of the motor shaft (in the exemplary embodiment, the actual position x_{Mact} should be understood as meaning the rotation angle of the motor shaft) is measured by a rotor position measurement system 12, adjacent to the motor 1, and the actual velocity v_{Mact} of the motor 1 is calculated from this by a differentiator 11. The control loop has a position regulator 4, to which the difference from the measured actual position x_{Mact} and the suitable position profile x_{M}*(t) is supplied and which outputs a nominal velocity vₙₒₘ on the output side. The difference is formed by means of a subtractor 8.

Furthermore, the control loop has a velocity regulator 5, to which a computation module 7 supplies the sum of the nominal velocity vₙₒₘ and the suitable velocity profile v_{M}*(t) minus the actual velocity v_{Mact} of the motor, and which outputs a nominal torque mₙₒₘ on the output side.

Furthermore, the control loop has a summing means 6, which determines the sum of the nominal torque mₙₒₘ and the suitable torque profile m_{M}*(t), and whose output variable (the sum of the nominal torque mₙₒₘ and the suitable torque profile m_{M}*(t)) influences the magnitude of the motor current I, via a current control loop 3. The position regulator 4 and the velocity regulator 5 are in this case used only to regulate out any possible differences which may occur between the actual mechanical system and the model that has been created. In the ideal, that is to say when the model and the actual mechanism match ideally, it would be sufficient to feed in the suitable torque profile m_{M}*(t) in order to carry out the optimized movement control of the movable machine element.

The position regulator 4 and the velocity regulator 5 would then not be needed.

Since the current control loop 3 has a time constant, even if this is very short (this is essentially the time, for example, to allow an associated converter to build up the appropriate current), it may be worthwhile for better matching to use a first delay element 9 and a second delay element 10 to delay the suitable position profile x_{M}*(t) and the suitable velocity profile v_{M}*(t) in time, in order to achieve time matching.

Since the mechanism which can oscillate has been taken into account in the production of the suitable position profile x_{M}*(t) and/or the suitable velocity profile v_{M}*(t) and/or the suitable torque profile m_{M}*(t), the invention makes it possible to avoid the trial and error process described in the introductory part of the description, and to shorten the development process and the start-up process. Furthermore, the suitable position profiles, suitable velocity profiles and/or suitable torque profiles which result from the optimization problem are, in contrast to conventional, specific movement profiles, defined not only by a large number of parameters which can be enumerated, such as the maximum velocity, maximum acceleration and maximum jerk, but in principle they may also assume any desired profiles, provided that these comply with the system restrictions. The additional degrees of freedom that this results in allows movement processes to be calculated with a considerably reduced movement time, and therefore with higher productivity.

At this point, it should be noted that, for example, means for filtering the input and/or output variables to the regulators can also be provided as an integral component of the position regulator 4 and/or of the velocity regulator 5.

At this point, it should also be noted that the invention may, of course, be used both for rotary movement processes and for linear movement processes.

1-15. (canceled)

16. A method for controlling movement of a movable machine element of a machine, comprising the steps of:
creating a model which simulates a machine axis,
inputting a movement to be performed by the machine element, and
determining with the model at least one of a position profile, a velocity profile and a torque profile suitable for optimized movement of the movable machine element, as well as a predetermined quality function and a limitation for the movement of the machine axis,
wherein the suitable position profile, velocity profile or torque profile is used as a reference or pilot-control variable in a control loop which controls the movable machine element, and
wherein the predetermined quality function is an integral of the square of a torque or of a variable which is directly related to the torque.

17. The method of claim 16, wherein inputting a movement comprises inputting an initial position or an end position, or both, of the movement to be performed by the machine element.

18. The method of claim 17, wherein inputting a movement comprises inputting a velocity of the machine element at the initial position or at the end position, or both.

19. The method of claim 17, further comprising the step of inputting a movement duration between the initial position and the end position.

20. The method of claim 16, wherein the model is created based on frequency response measurements, actual machine parameters or estimated machine parameter, or a combination thereof.

21. The method of claim 16, wherein creating the model comprises selecting by a user a form from a list of forms with parameters for typical machine types or machine kinematics, or both

22. The method of claim 16, wherein the model is a mass model which simulates only a mechanical configuration of the machine axis.

23. A device for controlling movement of a movable machine element of a machine, comprising:
means for creating of a model which simulates a machine axis,
means for inputting a movement to be performed by the machine element, and
means for determining with the model at least one of a position profile, a velocity profile and a torque profile suitable for optimized movement of the movable machine element, as well as a predetermined quality function and a limitation for the movement of the machine axis,
wherein the suitable position profile, velocity profile or torque profile is used as a reference or pilot-control variable in a control loop which controls the movable machine element, and
wherein the predetermined quality function is an integral of the square of a torque or of a variable which is directly related to the torque.

24. The device of claim 23, further comprising a position regulator having an input receiving a difference between an actual position and the suitable position profile, and an output supplying a nominal velocity, a velocity regulator having an input receiving a sum of a desired velocity and the suitable velocity profile minus an actual velocity, and an output supplying a nominal torque.

25. The device of claim 23, further comprising summing means, which determines a sum of a desired torque and the suitable torque profile and outputs an output variable which affects a magnitude of a motor current.

26. The device of claim 24, further comprising a first delay element disposed upstream of the position generator and time-delaying the suitable position profile, before the difference between the actual position and the suitable position profile is received at the input of the position regulator.

27. The device of claim 24, further comprising a second delay element disposed upstream of the velocity generator and time-delaying the suitable velocity profile, before the sum of the nominal velocity and the suitable velocity profile minus the actual velocity is formed.

28. The device of claim 24, wherein the machine is selected from the group consisting of machine tool, production machine and robot.

29. A method for controlling movement of a machine element associated with a machine axis of a machine, comprising the steps of:
creating a model which simulates the machine axis with the machine element,
inputting a movement to be performed by the machine element, and
determining with the model at least one of a position profile, a velocity profile and a torque profile suitable for optimized movement of the machine element, as well as a predetermined quality function and a limitation for the movement of the machine element,
wherein the suitable position profile, velocity profile or torque profile is used as a reference or pilot-control variable in a control loop which controls the movement of the machine element, and
wherein the predetermined quality function is an integral of the square of a torque or of a variable which is directly related to the torque.

30. A device for controlling movement of a machine element associated with a machine axis of a machine, the device comprising:
means for creating of a model which simulates the machine axis with the machine element,
means for inputting a movement to be performed by the machine element, and
means for determining with the model at least one of a position profile, a velocity profile and a torque profile suitable for optimized movement of the machine element, as well as a predetermined quality function and a limitation for the movement of the machine element,
wherein the suitable position profile, velocity profile or torque profile is used as a reference or pilot-control variable in a control loop which controls the movement of the machine element, and
wherein the predetermined quality function is an integral of the square of a torque or of a variable which is directly related to the torque.
